(19) United States
(12) Patent Application Publication
(10) Pub. No.: US 2013/0228047 A1
(43) Pub. Date: Sep. 5, 2013

(54) LOCKING STRUCTURE OF MULTIFUNCTIONAL STRIPPING/CUTTING PLIERS

(71) Applicant: SHYI-DONG YANG, Taichung City (TW)

(72) Inventor: SHYI-DONG YANG, Taichung City (TW)

(21) Appl. No.: 13/410,252

(22) Filed: Mar. 1, 2012

(51) Int. Cl. H02G 1/12

(52) U.S. Cl. 81/9.44

(57) ABSTRACT

Multifunctional stripping/cutting pliers are provided for stripping and cutting multi-wire and multi-core electrical cable. The stripping/cutting pliers have plate like bodies that are pivoted in an opposing manner and form in pivot disks thereof a receiving slot in which a spring is received in a concealed arrangement. A stepped hole is provided to extend through a middle portion of the pivoted bodies at a lower side of the insertion site of the spring for receiving a positioning pin to extend therein so as to provide an easy depression operation from the outside of the bides to realize locking. Through the concealed and position-returning arrangement of the spring of the stripping/cutting pliers and assisted by simple depression that achieves locking, the cutting operation of the stripping/cutting pliers can provides the effects of being easy, being practical, and operation and locking safety.

### (A) TECHNICAL FIELD OF THE INVENTION

The present invention generally relates to an improvement of locking structure of multifunctional stripping/cutting pliers, in which a predetermined receiving slot is formed in opposing surfaces of pivot disks of cutting bodies that are provided for wire stripping and cutting for receiving therein a position returning spring in a concealed arrangement and the pivot disks form, in a middle portion of the pivot disks below the portion where the spring is arranged, a through hole that have upper and lower segments of different diameter to receive a positioning pin to insert therein in such a way that a large-diameter hole formed in the lower segment of the stepped hole configuration receive therein a bottom end of the positioning pin that has an expanded diameter for easy operation of locking, allowing the cutting operation and storage of the stripping/cutting pliers to achieve the operation purposes of wire stripping and cutting that are easy in operation and safe in locking.

### (B) DESCRIPTION OF THE PRIOR ART

A conventional wire stripper is often provided with stripping/cutting notches having different cutting diameter to match wires of different covers and an example is illustrated in FIGS. 8 and 9, in which the wire stripper is composed of two clamp bodies 30 that are of configurations opposite to each other and have top ends forming jaw sections 31 that have opposite configuration of being recessed and raised. Lower edges of the jaw sections are connected, with wide surfaces, to integral pivot disks 32 a center of which is provided with a pivot pin 33 that pivotally joint the opposing bodies 30 to form a complete outside configuration of pliers. Lower ends of the pivot disks 32 form, at inner sides thereof with respect to the bodies 30, positioning projections 34 to allow a spring 35 to be mounted between the bodies 30 for assistance of position returning for opening and closing in performing cutting operations. At one side of the lower ends of the pivot disks 32, an L-shaped control plate 36 is pivotally mounted, whereby through proper operation, a top end of the L-shaped plate can be set, in a closed condition, into a predetermined cutoff formed in a lower edge of the disk of the other body 30 to realize closing and positioning for closing the pliers so as to ensure safe use of the stripper in successive cutting operations and storage. Extended ends of the two pivotally jointed bodies 30 are respectively fit with plastic covers to form comfortable hand grip for easy hand holding and gripping. As such a complete structure of wire stripper is formed.

Such a conventional structure of wire stripper is disadvantageous in cutting operation in that in the operation of the stripper, since the position-returning spring 35 is arranged below the central pivot pin 33, due to the need for proper positioning, the positioning projections must be made long and this causes inconvenience in assembling the spring 35. Further, to accommodate the spring 35 to be assembled by being mounted outside, the pliers must be extended in length to provide an accommodation space and this increases the material cost of the pliers and makes the pliers bulky and heavy in hand holding, and what is more troublesome is that the spring 35 is often a coil spring and spacing between adjacent turns of the spring may inadvertently clamp a wire or a thin object therein and further, unexpected activation may cause an operator's hand to be accidently pinched and hurt. This causes problems of safety of use and position returning by the spring. Further, the control plate 36 is pivoted at a lower edge of a corner, the L-shaped plate must be arranged in a raised manner of assembling to allow another hand to readily operate and control. Such a controlling operation is not convenient and it may often occur that the raised and irregular configuration may easily cause the raised control plate to contact and hook an object nearby or being accidently activated by an operator's hand, making the locking unexpected released, which leads to accident expansion of the pliers and thus a problem of safety may happen. Regarding to the cutting operation of the conventional stripper for cutting multiple-core wires, a concern is how to simplify the operation of cutting and stripping wires and how to provide a concealed arrangement for those parts/devices that may lead to problems of safety in order to realize safe operation and use and to make the devices for cutting and stripping wires more practical in use and showing a more beautiful and safer structural arrangement.

### SUMMARY OF THE INVENTION

The present invention aims to provide a locking structure of multifunctional stripping/cutting pliers, which forms a predetermined receiving slot in opposing surface of pivot disks of pivoted half bodies of the pliers to receive a spring therein for concealed arrangement and a hole having upper and lower segments having different diameters is formed below a pivot pin that pivotally joint the bodies to receive the extension of a positioning pin having a stepped configuration to thereby provide an easy pressing operation and to achieve a safe arrangement for cutting and storage thereby effectively overcome the problems associated with position returning and caused by exposed arrangement of control plate.

The object of the present invention is that a predetermined receiving slot is formed in inside surfaces of pivot disks of stripping/cutting bodies to receive a position returning spring therein to form a concealed arrangement and a through hole having an inverted T-shaped cross section comprising upper and lower segments in alignment with each other is formed to receive easy insertion of a positioning pin, which is used in combination with elastic depression and displacement of a spring to provide an easy locking arrangement by simply inserting the positioning pin in closing and storing the pliers, whereby the position returning spring and the positioning pin can be easy assembled to provide convenience and practical safe of the cutting operations of the stripping/cutting pliers.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of stripping/cutting pliers according to the present invention.

FIG. 2 is a perspective view of the stripping/cutting pliers of the present invention in a condition ready for cutting.

FIG. 3 is a perspective view of the stripping/cutting pliers of the present invention in a closed condition.

FIG. 4 is a schematic view showing a pliers mouth in an open condition after position returning in the operation of the stripping/cutting pliers.

FIG. 5 is a schematic view illustrating positioning of the pliers mouth for the pliers in a closed and locked condition.

FIG. 6 is a schematic view showing the assembly of a positioning pin in an open condition of the stripping/cutting pliers.

FIG. 7 is a schematic view showing the assembly of the positioning pin in a closed and locked condition of the stripping/cutting pliers.

FIG. 8 is an exploded view of a conventional wire stripper.

FIG. 9 is perspective view showing the conventional wire stripper in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

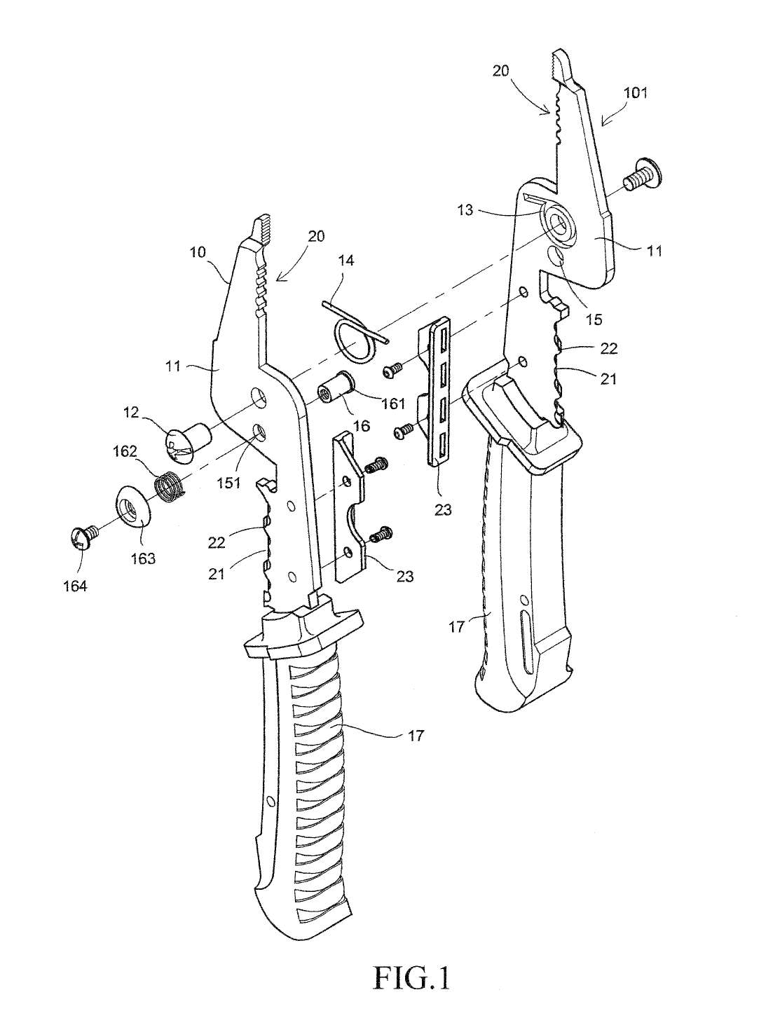

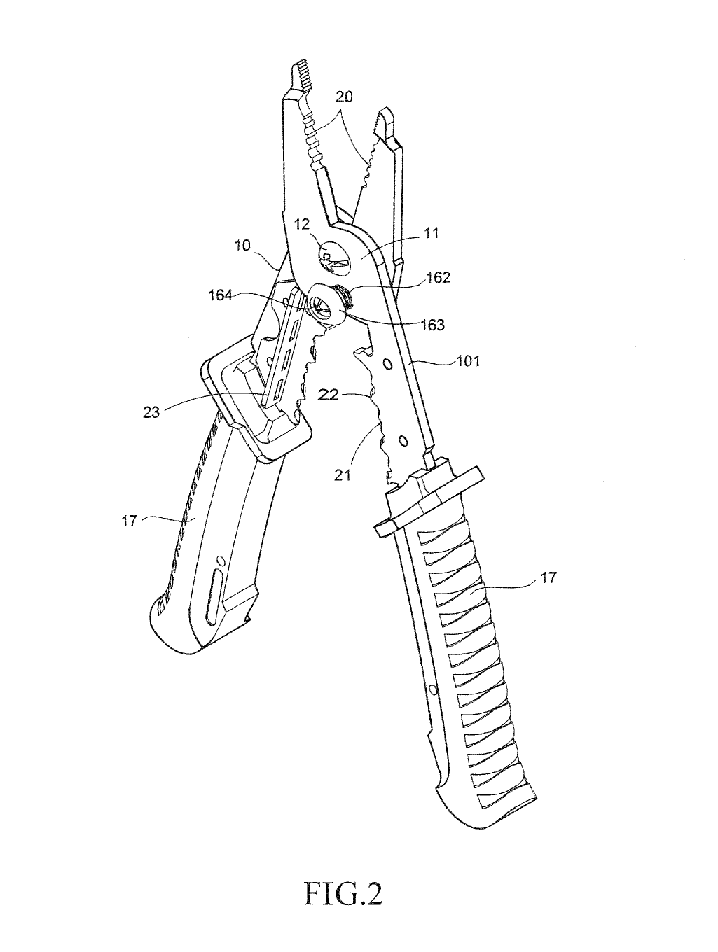

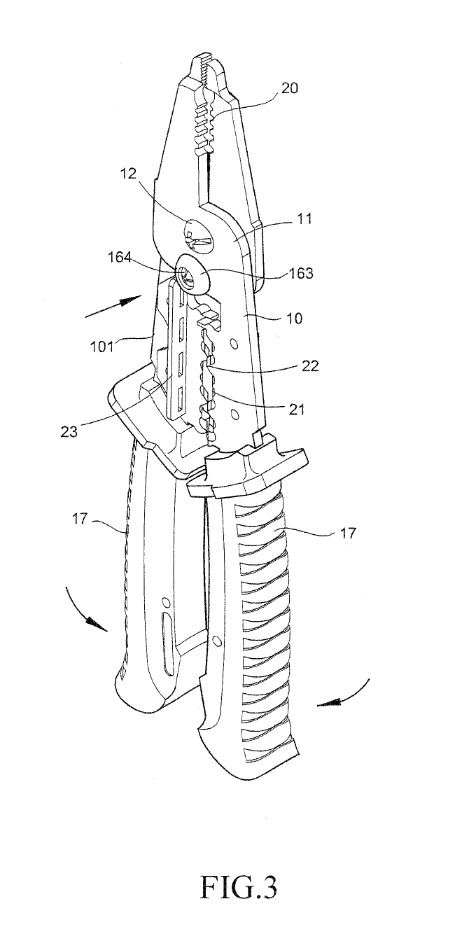

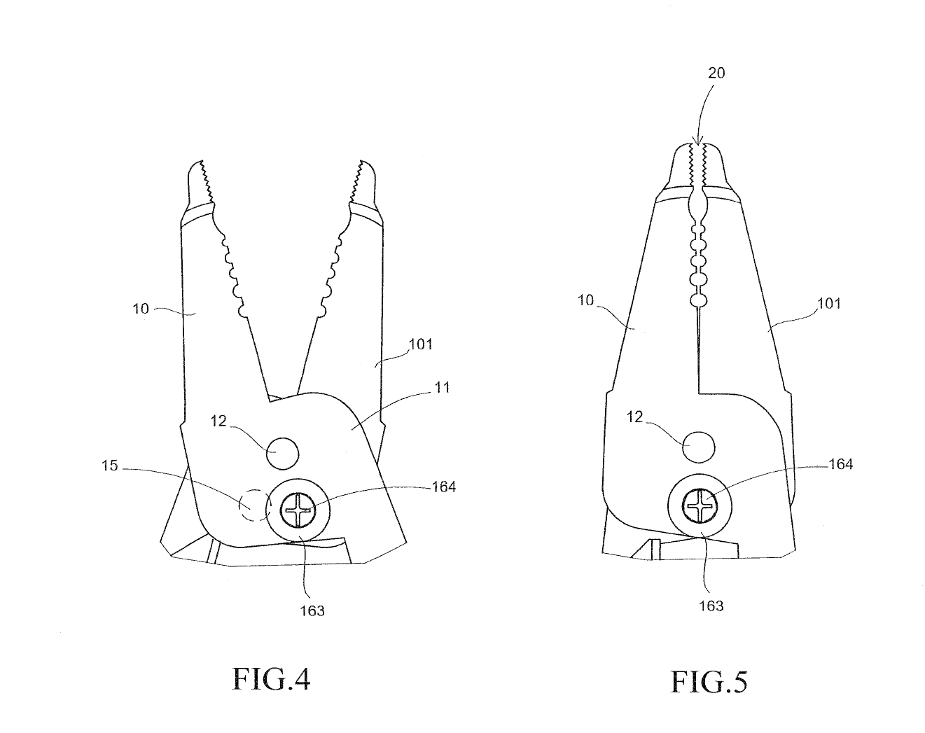

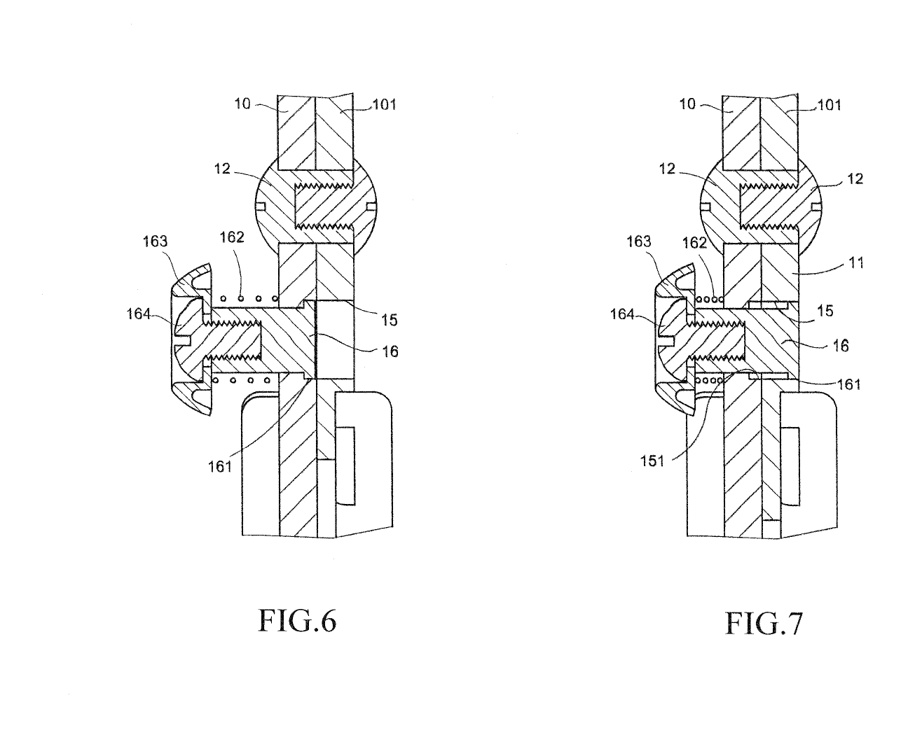

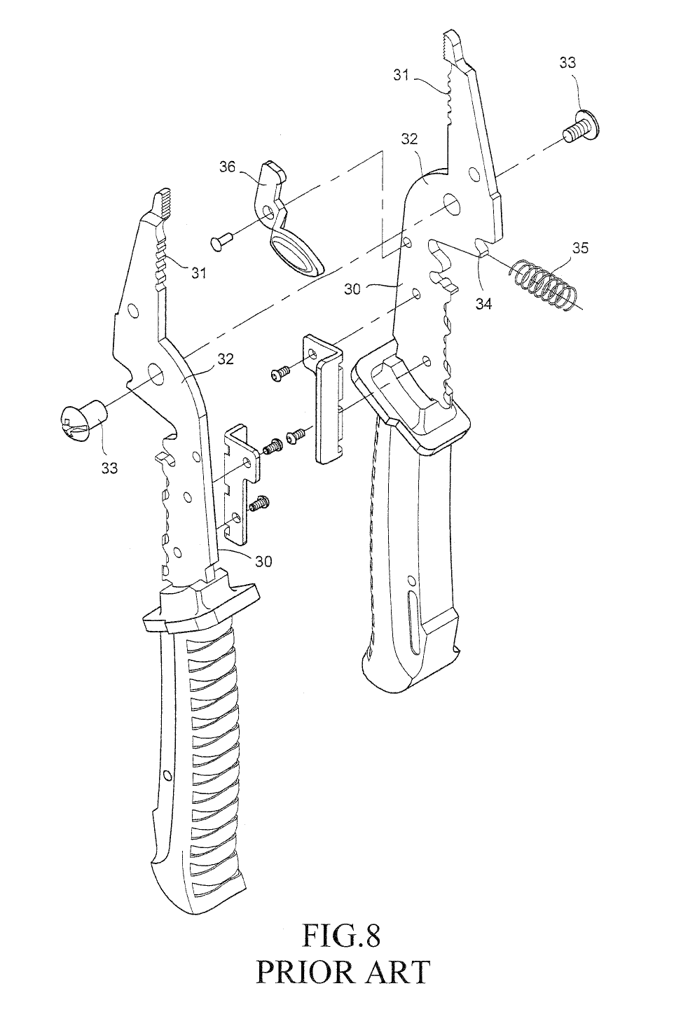

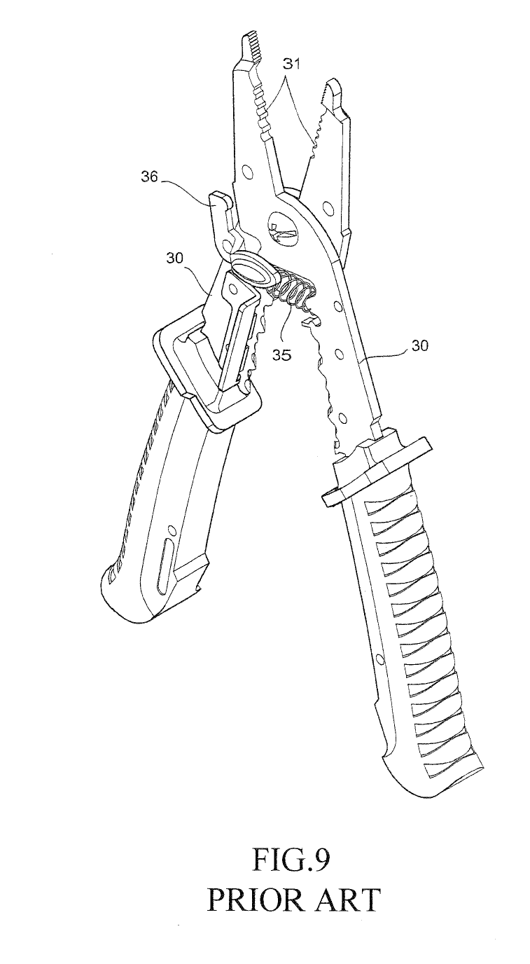

The present invention provides multifunctional stripping/cutting pliers, of which an overall configuration shows an outside appearance similar to a conventional wire stripper but an improvement of the present invention over the conventional wire stripper is that a position-returning mechanism that is provided for facilitating the operation of the pliers is of a concealed arrangement and a locking mechanism that is provided for securing pliers mouth in a closed position when the pliers are closed is arranged in pivot disks at a lower portion below a center of the pivot disks to provide simple and easy locking and positioning through an elasticity based simple press-down operation. A description of the improvement of the stripping/cutting pliers according to the present invention will be described with reference to FIGS. 1-7. Structurally, the pliers are composed of two plate-like half bodies 10, 101 that are arranged to overlap and pivot to each other by having pivot disks of the half bodies jointed, at a center thereof, to each other by a pivot pin 12. Formed in inside surfaces of the pivot disks 11 of the bodies 10, 101 that are jointed to each other, at locations in an outer circumferential portion around the pivot pin 12, are halves of a receiving slot 13 that are respectively recessed in the inside surfaces and show a shape corresponding to the outline of a position-returning spring 14, such a shape being an elongate configuration or a looped configuration, for receiving and holding the spring 14 therein. Further, in the portions of the disks below the position-returning spring 14, one of the pivot disks, such as the pivot disk 11, forms, in a lower portion thereof a through hole 15 having a relatively large diameter and the other pivot disk forms, in an opposite portion, a stepped hole 151 of which a bottom segment has a relatively large diameter corresponding to the through hole 15, whereby a positioning pin 16 that is of an arrangement having an outside diameter of substantially the same size is set in such a way that a large-diameter end flange 161 is received in the relatively large diameter segment in a slidable manner for being deposited therein. The positioning pin 16 is set to extend through the through hole from inside to outside to receive a spring 162 that is set encompass the portion of the pin extending beyond the through hole and a cap 163 is then coupled to a distal end of the pin to complete cover, hold, and compress the spring 162 for the purposes of elastic returning of the positioning pin 16, as shown in FIG. 6. The cap 163 forms in a center thereof an inward recessed cavity, whereby a screw 164 for coupling purposes is completely received and embedded in the central cavity of the cap 163 to provide a safe and aesthetic assembly. Through a user's operation with a single hand to press down the positioning pin 16, after the stripping/cutting pliers are closed, the positioning pin 16 can be simply pressed down from the outside to undergo a deeply inward displacement to such a location where the bottom end flange 161 enters the through hole 15. After the force applied to hold and control the pliers is released, the spring force of the internally-accommodated spring 14 causes the positioning pin 16 and the through hole 15 engage each other and thus fixed together, whereby the pivoted bodies 10, 101 are not allowed to carry out a cutting and shearing operation and show a fixed condition. When it is attempted to carry out a cutting and shearing operation, a single hand holds and forcibly grips the handle sections 17 of the pliers to have then close to each other, making the through hole 15 and the stepped hole 151 in registration with each other again. A returning operation assisted by the spring force of the spring 162 mounted around an end portion of the positioning pin 16 pushes the cap 163 in an upward and outward direction, whereby the positioning pin 16 can be moved to the upmost position where the expanded end flange 161 is again received in the large-diameter bottom segment of the stepped hole 151. The pliers are now allowed to close and open for performing cutting and shearing operations. This provides secure locking and control of the stripping/cutting pliers in both cutting operations and storage.

Jaw sections 20 are formed at a portion above the pivot pin 12 of the stripping/cutting pliers for clamping and stripping wires, in order to easily perform clamping and stripping operations of wires. Cutting notches 21, which are arranged in a configuration of multiple successive segments, are formed in opposing edges of plate like handle bodies of portions below the pivot pin 12, and form various concave arc like stripping/cutting edges according to jacket widths of multiple core wires, which may wires of two or three cores. Between adjacent ones of the cutting notches 21, a raised ridge 22 is formed for separation and connection to facilitate deposition of wires having different numbers of core to be inserted therein for performance of cutting and stripping operation. At the side of the cutting notches 21 from which the wires are inserted, a supporting positioning tab 23 is first secured at a lower edge of the cutting notches 21 for the purposes of supporting to assist locking. On the opposite side of the cutting notches 21 above the extension end, an identical supporting positioning tab 23 is mounted, so that in carrying out a stripping and cutting operation of a wire, the two sides of cutting can be maintained at the same plane to maintain perpendicularity of cutting surface and facilitate the performance of the cutting operation. At lower ends of the extended handle sections 17 that are pivoted together, plastic covers are fit to form handle grips that are comfortable to hold by hand. As such, a complete structure of stripping and cutting pliers is completed.

The improved feature of the stripping and cutting pliers according to the present invention is that the spring 14 for returning purpose for the cutting operation is arranged such that the spring 14 is securely assembled in a concealed manner in opposing portions of the receiving slot 13 that are formed in the disk surface around an outer circumference of the pivot pin 12 that pivotally joint the bodies 10, 101 so that in carrying out stripping and cutting operations, cutting actions and automatic returning can be successively performed and the outside configuration of the whole pliers are made concise and compact, effectively reducing the overall length of the pliers and correspondingly the material used being reduced to realize improvement for making the pliers light-weighted. To store the stripping and cutting pliers, the locking arrangement for the pliers mouth is made such that a through hole 15 and a stepped hole 151 are formed in the disk surfaces of the pivot disks 11 of two pivotally jointed bodies 10, 101 at a portion below the center thereof and a positioning pin 16 having an end flange 161 that is expanded and formed at a bottom end thereof is inserted upward in the stepped hole 151 and is encompassed by a spring 162 outside the pivot disk 11 to be secured by a cap 163 and a screw 164 thereby making is slidable for extension and retraction. As such, by pressing the end flange 161 deeply into the through hole 15 that is of a relatively large diameter and is located at an opposite side, locking and positioning for storage in a closed condition can be realized so that the operation of storing the stripping and cutting pliers can be achieved and the need for one hand operation in a safe and simple way can be obtained through simple depression. The overall arrangement of having L-shaped positioning tabs 23 at outside of the cutting notches 21 for assistance of cutting and the unique concealed arrangement of spring 14 for position returning and the secured and locked storage allow the operation and storage of the stripping and cutting pliers to be easy and secured and this is a great improvement of the structural design of the stripping and cutting pliers.

In summary, the locking structure of multifunctional stripping/cutting pliers according to the present invention arranges position-returning spring for cutting operation of the pliers and positioning device for locking the pliers in such a way as to be operable by a simple depressing operation so that structural features that the overall outside configuration of the pliers are beautiful and the operation is safe can be realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. Multifunctional stripping/cutting pliers, comprising half bodies that are pivoted to each other, the bodies having pivot disks that are jointed by a pivot pin, upper portions of the bodies above the pivot pin forming jaw sections, opposite edges of lower sides of the pivot disks being beveled and forming successive half-shaped arc-wavy cutting notches, handle grips extending downward receiving plastic covers to fit thereon to form handle sections, and a spring provided for position returning for opening/closing of the pliers in performing cutting operations, characterized in that a receiving slot is formed by recessing surfaces of the pivot disks of the bodies along an outer circumference about the central pivot pin to receive the position-returning spring therein in a concealed arrangement, a through hole and a stepped hole being respectively formed in the disks of the two half bodies at opposing location in the lower sides of the spring to correspond to each other, the stepped hole having a bottom segment that has a diameter corresponding to diameter of the through hole, the bottom segment of the stepped hole movably receiving a positioning pin having an end forming an expanded end flange in such a way that the positioning pin projects outside the disk to receive a spring fit thereto and secured by a cap and a bolt thereby forming an elastic positioning device that is easy to operate through depressing, which allows the stripping/cutting pliers, in performing a cutting operation, to do successive operations of cutting with automatic opening/closing, wherein to store in a closed condition, the positioning pin is pressed down to deeply insert into the through hole of the opposite body to realize secure closed and locked condition of the jaw sections.

2. The multifunctional stripping/cutting pliers according to claim 1, wherein the cap forms, in a central portion thereof, a recessed cavity to receive therein the screw so that the screw does not project beyond the cap.

3. The multifunctional stripping/cutting pliers according to claim 1, wherein the receiving slot is composed of two halves respectively formed by recessing the opposing pivot disks of the two bodies to completely receive the spring therein.

4. The multifunctional stripping/cutting pliers according to claim 1, wherein the receiving slot is of an elongate slot configuration or a looped configuration.
